(19) United States
(12) Patent Application Publication
(10) Pub. No.: US 2026/0052444 A1
(43) Pub. Date: Feb. 19, 2026

(54) L1/L2-Based Conditional Mobility

(71) Applicant: Apple Inc., Cupertino, CA (US)

(72) Inventors: Naveen Kumar R PALLE VENKATA, San Diego, CA (US); Fangli XU, Beijing (CN); Haijing HU, Los Gatos, CA (US); Yuqin CHEN, Beijing (CN); Zhibin WU, Los Altos, CA (US); Peng CHENG, Beijing (CN); Ping-Heng KUO, London (GB); Ralf ROSSBACH, Munich (DE); Hong HE, San Jose, CA (US)

(21) Appl. No.: 19/102,199

(22) PCT Filed: Aug. 9, 2022
(86) PCT No.: PCT/CN2022/111275

§ 371 Date: Feb. 7, 2025

(51) Int. Cl. H04W 36/08; H04W 36/00

(52) U.S. Cl. CPC H04W 36/087; H04W 36/0058

(57) ABSTRACT

Embodiments of the present disclosure relate to mobility. According to embodiments of the present disclosure, a UE comprises a transceiver configured to communicate with a network; and a processor communicatively coupled to the transceiver and configured to perform operations. The operations comprise receiving, using the transceiver, from a CU of a base station, a set of configurations of a set of candidate cells for at least one of intra-DU mobility or inter-DU mobility and a set of L1/L2-based conditional trigger configurations associated with the set of candidate cells; and in accordance with a determination that a L1/L2-based conditional trigger configuration among the set of L1/L2-based conditional trigger configurations is satisfied, performing a L1/L2-based handover to a target cell, among the set of candidate cells, associated with the L1/L2-based conditional trigger configuration based on a configuration of the target cell among the set of configurations. In this way, mobility latency may be reduced.

### TECHNICAL FIELD

Embodiments of the present disclosure generally relate to the field of telecommunications, and in particular, to L1/L2-based conditional mobility.

### BACKGROUND

A base station (BS) may comprise a central unit (CU) and one or more distributed units (DUs). Operations of the DU may be partly controlled by the CU. The CU may terminate the F1 interface connected with the DU. The DU may support one or more cells. One cell is supported by only one DU. The DU may terminate the F1 interface connected with the CU.

The DU may serve one or more user equipments (UEs) directly connected to the DU. A UE may be provided with a list of target cells for conditional handover (CHO). Based on measurements, a UE may perform an intra-DU mobility procedure so as to move from one cell provided by a DU to another cell provided by the DU. Alternatively, the UE may perform an inter-DU mobility procedure so as to move from a cell provided by one DU to a cell provided by another DU controlled by the same CU. However, enhancements on conditional mobility procedure need to be further developed.

### SUMMARY

In general, example embodiments of the present disclosure provide a solution for L1/L2-based conditional mobility.

In a first aspect, there is provided a UE. The UE comprises a transceiver and a processor. The transceiver is configured to communicate with a network. The processor is communicatively coupled to the transceiver and configured to perform operations comprising: receiving, using the transceiver, from a CU of a base station, a set of configurations of a set of candidate cells for at least one of intra-DU mobility or inter-DU mobility and a set of L1/L2-based conditional trigger configurations associated with the set of candidate cells; and in accordance with a determination that a L1/L2-based conditional trigger configuration among the set of L1/L2-based conditional trigger configurations is satisfied, performing a L1/L2-based handover to a target cell, among the set of candidate cells, associated with the L1/L2-based conditional trigger configuration based on a configuration of the target cell among the set of configurations.

In a second aspect, there is provided a DU of a BS. The DU comprises a transceiver and a processor. The transceiver is configured to communicate with a UE. The processor is communicatively coupled to the transceiver and configured to perform operations comprising: receiving, using the transceiver, from a CU of the base station, a set of configurations of a set of candidate cells for at least one of intra-DU mobility or inter-DU mobility of the UE and a set of L1/L2-based conditional trigger configurations associated with the set of candidate cells; and transmitting, using the transceiver, to the UE, the set of configurations and the set of L1/L2-based conditional trigger configurations.

In a third aspect, there is provided a CU of a BS. The CU comprises a transceiver and a processor. The transceiver is configured to communicate with a UE. The processor is communicatively coupled to the transceiver and configured to perform operations comprising: receiving, using the transceiver, from at least one candidate DU of the base station, a set of handover information associated with a set of candidate cells for at least one of intra-DU mobility or inter-DU mobility of the UE, the set of candidate cells belonging to the at least one candidate DU; determining a set of L1/L2-based conditional trigger configurations associated with the set of candidate cells based on the set of handover information; and transmitting, using the transceiver, to the UE, a set of configurations of the set of candidate cells and the set of L1/L2-based conditional trigger configurations.

In a fourth aspect, there is provided a processor of a UE. The processor is configured to perform operations comprising: receiving, using a transceiver of the UE, from a CU of a base station, a set of configurations of a set of candidate cells for at least one of intra-DU mobility or inter-DU mobility and a set of L1/L2-based conditional trigger configurations associated with the set of candidate cells; and in accordance with a determination that a L1/L2-based conditional trigger configuration among the set of L1/L2-based conditional trigger configurations is satisfied, performing a L1/L2-based handover to a target cell, among the set of candidate cells, associated with the L1/L2-based conditional trigger configuration based on a configuration of the target cell among the set of configurations.

In a fifth aspect, there is provided a processor of a DU of a BS. The processor is configured to perform operations comprising: receiving, using a transceiver of the DU, from a CU of the base station, a set of configurations of a set of candidate cells for at least one of intra-DU mobility or inter-DU mobility of the UE and a set of L1/L2-based conditional trigger configurations associated with the set of candidate cells; and transmitting, using the transceiver, to the UE, the set of configurations and the set of L1/L2-based conditional trigger configurations.

In a sixth aspect, there is provided a processor of a CU of a BS. The processor is configured to perform operations comprising: receiving, using a transceiver of the CU, from at least one candidate DU of the base station, a set of handover information associated with a set of candidate cells for at least one of intra-DU mobility or inter-DU mobility of the UE, the set of candidate cells belonging to the at least one candidate DU; determining a set of L1/L2-based conditional trigger configurations associated with the set of candidate cells based on the set of handover information; and transmitting, using the transceiver, to the UE, a set of configurations of the set of candidate cells and the set of L1/L2-based conditional trigger configurations.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a signaling chart illustrating a process for mobility in accordance with some example embodiments of the present disclosure;

FIG. 3 illustrates a signaling chart illustrating a process for UE-triggered conditional mobility in accordance with some example embodiments of the present disclosure;

FIG. 4 illustrates a signaling chart illustrating a process for L1/L2-based mobility triggered by NW in accordance with some example embodiments of the present disclosure;

FIG. 5A illustrates an exemplary IE reusing the existing measurement configuration in accordance with some example embodiments of the present disclosure;

FIG. 5B illustrates an exemplary IE for measurement configuration for L1/L2-based mobility in accordance with some example embodiments of the present disclosure;

FIG. 5C illustrates an exemplary IE for measurement configuration specific to a L1/L2 candidate cell configuration in accordance with some example embodiments of the present disclosure;

FIG. 5D illustrates an exemplary IE for CSI measurement configuration in accordance with some example embodiments of the present disclosure;

FIG. 5E illustrates an exemplary IE for report configuration in accordance with some example embodiments of the present disclosure;

FIG. 5F illustrates an exemplary MSG3 MAC CE for handover confirmation in accordance with some example embodiments of the present disclosure;

FIG. 6A illustrates a signaling chart illustrating a process for measurement reporting and re-configuration of UE in accordance with some example embodiments of the present disclosure;

FIG. 6B illustrates an exemplary DL DCI L1 mobility configuration message for measurement reconfiguration in accordance with some example embodiments of the present disclosure;

FIG. 6C illustrates an exemplary CSI PUCCH report message in accordance with some example embodiments of the present disclosure;

FIG. 6D illustrates an exemplary MAC CE measurement configuration message for measurement reconfiguration in accordance with some example embodiments of the present disclosure;

FIG. 6E illustrates an exemplary MAC CE measurement report message in accordance with some example embodiments of the present disclosure;

FIG. 7 illustrates a signaling chart illustrating a process for protective L1 signaling and L2 messages in accordance with some example embodiments of the present disclosure;

FIG. 8 illustrates a flowchart illustrating an example method for L1/L2-based conditional mobility implemented at a UE in accordance with some example embodiments of the present disclosure;

FIG. 9 illustrates a flowchart illustrating an example method for L1/L2-based conditional mobility implemented at a source DU of a BS in accordance with some example embodiments of the present disclosure;

FIG. 10 illustrates a flowchart illustrating an example method for L1/L2-based conditional mobility implemented at a CU of a BS in accordance with some example embodiments of the present disclosure; and

FIG. 11 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (4° C.), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment”and “UE”may be used interchangeably.

As mentioned above, a UE may perform a conditional mobility procedure so as to move from a cell provided by one DU to a cell provided by another DU controlled by the same CU. Conventionally, the handover procedure is based on L3-mobility, which might result in high latency.

Embodiments of the present disclosure propose a solution for L1/L2-based conditional mobility. In this solution, the UE may be pre-configured with a set of configurations of a set of candidate cells for at least one of intra-DU mobility or inter-DU mobility and a set of L1/L2-based conditional trigger configurations associated with the set of candidate cells. When a L1/L2-based conditional trigger configuration is satisfied, the UE may directly perform a L1/L2-based handover to a target cell selected from the multiple candidate cells based on the pre-configured configuration of the target cell. According to embodiments of the present disclosure, the latency for handover procedure may be reduced. Principles and example embodiments of the present disclosure will be described in detail below with reference to the accompanying drawings.

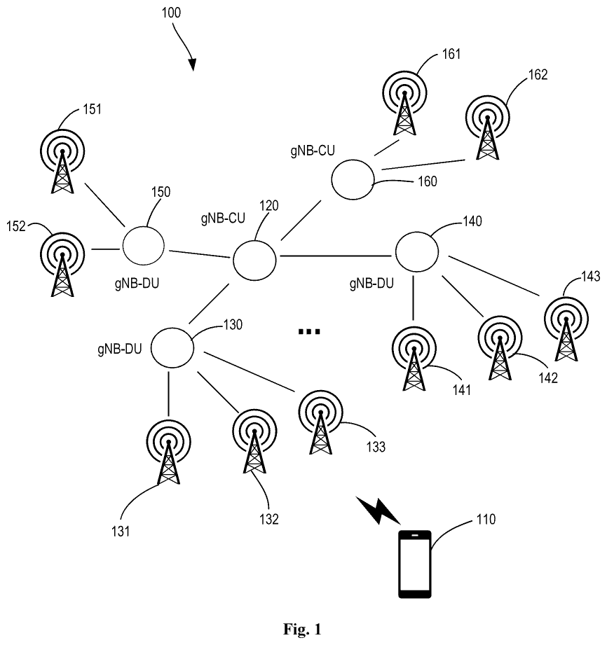

FIG. 1 shows an example communication network 100 in which embodiments of the present disclosure can be implemented. The network 100 may comprise a base station. The base station may comprise a CU and one or more DUs. In some embodiments, the base station may be a gNB, eNB and so on. In the example of FIG. 1, the base station is illustrated as a gNB. In such an example, the CU of the base station may be referred to as a gNB-CU, and the DU of the base station may be referred to as a gNB-DU.

As shown in FIG. 1, the network 100 may comprise a UE 110, gNB-CUs 120 and 160, a first gNB-DU 130, a second gNB-DU 140 and a third gNB-DU 150. The first gNB-DU 130, the second gNB-DU 140 and the third gNB-DU 150 are connected to the gNB-CU 120. Operations of the first gNB-DU 130, the second gNB-DU 140 and the third gNB-DU 150 may be partly controlled by the gNB-CU 120. The gNB-CU 120 may terminate the F1 interface connected with each of the first gNB-DU 130, the second gNB-DU 140 and the third gNB-DU 150. Each of the first gNB-DU 130, the second gNB-DU 140 and the third gNB-DU 150 may terminate the F1 interface connected with the gNB-CU 120. The gNB-CU 120 may be a logical node hosting at least one of radio resource control (RRC), service data adaption protocol (SDAP) and packet data convergence protocol (PDCP) protocols of the base station. The gNB-CU 160 may be a logical node hosting at least one of RRC, SDAP and PDCP protocols of another base station.

Each of the first gNB-DU 130, the second gNB-DU 140 and the third gNB-DU 150 may be a logical node hosting at least one of radio link control (RLC), medium access control (MAC) and physical (PHY) layers of the base station. Each of the first gNB-DU 130, the second gNB-DU 140 and the third gNB-DU 150 may provide or support one or more cells. One cell is supported by only one DU. For example, the first gNB-DU 130 may provide cells 131, 132 and 133, the second gNB-DU 140 may provide cells 141, 142 and 143, and the third gNB-DU 150 may provide cells 151 and 152. The gNB-CU 160 may also provide or support one or more cells. For example, the gNB-CU 160 may provide cells 161 and 162.

It is to be understood that the numbers of UEs, CUs and DUs are only for the purpose of illustration without suggesting any limitations to the present disclosure. The network 100 may include any suitable number of UEs, CUs and DUs adapted for implementing implementations of the present disclosure.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (4C), the fourth generation (4G), 4.5G, the fifth generation (5G) communication protocols.

The UE 110 may access one cell provided by the first gNB-DU 130. For example, the UE 110 may be initially connected to the cell 133 provided by the first gNB-DU 130. Based on measurements, the UE 110 may perform an intra-DU mobility procedure so as to move from the cell 133 to another cell provided by the first gNB-DU 130. For example, the UE 110 may perform an intra-DU mobility procedure so as to move from the cell 133 to one of the cells 131 and 132. Hereinafter, the intra-DU mobility is also referred to as intra-gNB-DU mobility.

Alternatively, based on measurements, the UE 110 may perform an inter-DU mobility procedure so as to move from a cell provided by the first gNB-DU 130 to a cell provided by the second gNB-DU 140 or the third gNB-DU 150. For example, the UE 110 may perform an inter-DU mobility procedure so as to move from the cell 133 provided by the first gNB-DU 130 to one of the cells 141, 142 and 143 provided by the second gNB-DU 140. Hereinafter, the inter-DU mobility is also referred to as inter-gNB-DU mobility.

In some embodiments, the UE 110 may be in dual connectivity (DC) with the gNB-CUs 120 and 160. The intra-DU mobility procedure and the inter-DU mobility procedure may be allowed when the gNB-CU 120 is configured as a secondary node (SN) in a DC configuration while the gNB-CU 160 is configured as a master node (MN).

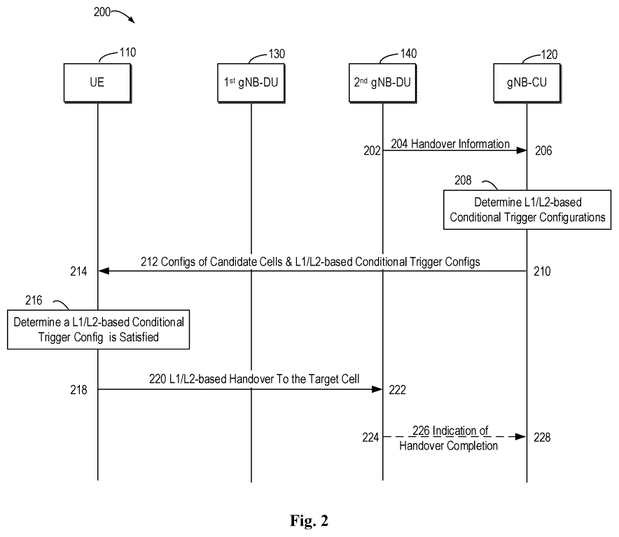

FIG. 2 illustrates a signaling chart illustrating a process 200 for mobility in accordance with some example embodiments of the present disclosure. For the purpose of discussion, the process 200 will be described with reference to FIG. 1. The process 200 may involve the UE 110, the gNB-CU 120, the first gNB-DU 130 and the second gNB-DU 140 in FIG. 1.

As shown in FIG. 2, the gNB-CU 120 receives 206, from at least one candidate gNB-DU, a set of handover information 204 associated with a set of candidate cells for at least one of intra-DU mobility or inter-DU mobility of the UE. The set of candidate cells belong to the at least one candidate gNB-DU. For example, in the embodiments where the UE 110 initially accesses the cell 133 provided by the first gNB-DU 130, the set of candidate cells may comprise the cells 131 and 132 for intra-DU mobility and the cells 141, 142 and 143 for inter-DU mobility.

The gNB-CU 120 determines 208 a set of L1/L2-based conditional trigger configurations associated with the set of candidate cells based on the set of handover information 204 and transmits 210, to the UE 110, a set of configurations of the set of candidate cells and the set of L1/L2-based conditional trigger configurations 212. The gNB-CU 120 may use the first gNB-DU 130 to relay the set of configurations of the set of candidate cells and the set of L1/L2-based conditional trigger configurations 212. The UE 110 receives 214, from the gNB-CU 120, the set of configurations of the set of candidate cells and the set of L1/L2-based conditional trigger configurations 212. The UE 110 may determine 216 that a L1/L2-based conditional trigger configuration among the set of L1/L2-based conditional trigger configurations is satisfied. Based on the determination 216, the UE performs 218 a L1/L2-based handover 220 to a target cell, among the set of candidate cells, associated with the L1/L2-based conditional trigger configuration based on a configuration of the target cell among the set of configurations.

In embodiments where the target cell is selected from a subset of candidate cells for inter-DU mobility (e.g., the cells 141, 142 and 143) among the set of candidate cells, e.g., if the target cell is cell 141, the UE 110 may perform 230 a handover to the target cell by performing an inter-DU mobility procedure. The second gNB-DU 140 to which the target cell belongs performs 222 the handover 220 of the UE 110 from the source cell and transmits 224, to the gNB-CU 120, an indication 226 of completion of the handover 220 of the UE 110 from a source cell of the first gNB-DU 130 to the target cell of the second gNB-DU 140. The gNB-CU 120 receives 228 the indication 226 of completion of the handover 220 from the second gNB-DU 140.

In embodiments where the target cell is selected from a subset of candidate cells for intra-DU mobility (e.g., the cells 131 and 132) among the set of candidate cells, e.g., if the target cell is cell 132, the UE 110 may perform a handover to the target cell by performing an intra-DU mobility procedure. The first gNB-DU 130 to which the target cell belongs performs the handover of the UE 110 from the source cell and transmits, to the gNB-CU 120, an indication of completion of the handover of the UE 110 from a source cell of the first gNB-DU 130 to the target cell of the first gNB-DU 130. The gNB-CU 120 receives the indication of completion of the handover from the first gNB-DU 130. In the process 200, because the set of configurations of the set of candidate cells for at least one of intra-DU mobility or inter-DU mobility are provided to the UE 110 before the handover, L1/L2-based conditional handover may be supported, thus reducing mobility latency.

In some example embodiments, the gNB-CU 120 may transmit, to a candidate gNB-DU to which a candidate cell of the set of candidate cells belongs, an indication of pre-configuring a L1/L2-based conditional handover of the UE 110. The candidate gNB-DU (e.g., the second gNB-DU 140) may transmit 202 the handover information associated with candidate cell(s) of the candidate gNB-DU for at least one of intra-DU mobility or inter-DU mobility of the UE 110. In this manner, the gNB-CU may obtain information about the candidate cells for conditional configuration.

In some example embodiments, when receiving the set of configurations and the set of L1/L2-based conditional trigger configurations 212, the UE 110 may receive from the gNB-CU 120, a first Radio Resource Control (RRC) message comprising the set of configurations and receive from the gNB-CU 120, a second RRC message different from the first RRC message. The second RRC message may comprise the set of L1/L2-based conditional trigger configurations, and an indicator associating one of the set of L1/L2-based conditional trigger configurations with one of the set of candidate cells. Alternatively, when receiving the set of configurations and the set of L1/L2-based conditional trigger configurations 212, the UE 110 may receive from the gNB-CU 120, a RRC message comprising the set of configurations and the set of L1/L2-based conditional trigger configurations. In some example embodiments, the UE 110 may receive from the gNB-CU 120, a third RRC message comprising the set of measurement configurations. In this manner, the necessary information for conditional mobility may thus be provided to the UE.

In some example embodiments, the UE 110 may obtain a set of measurement configurations for the set of candidate cells and transmit, to the gNB-DU 130 serving the UE 110, a measurement report associated with the set of measurement configurations. In some embodiments, the set of measurement configurations may comprise configurations of reference signals to be received from the set of candidate cells. Alternatively or additionally, the set of measurement configurations may comprise configurations of measurements to be performed by the UE 110 using the reference signals. Alternatively or additionally, the set of measurement configurations may comprise a reporting type associated with the measurements. Alternatively or additionally, the set of measurement configurations may comprise Quasi Co-Located (QCL) information associated with the reference signals. In this way, L1/L2-based conditional handover may be supported.

In some example embodiments, the first gNB-DU 130 may transmit the set of measurement configurations to the gNB-CU 120 through a F1 interface. The gNB-CU 120 may receive the set of measurement configurations from the first gNB-DU 130 and transmit a RRC message comprising the set of measurement configurations to the UE 110. The gNB-CU 120 may use the first gNB-DU 130 to relay the RRC message. In this way, the measurement configurations may be provided in a secure way.

In some example embodiments, the gNB-CU 120 may transmit a RRC message comprising a plurality set of measurement configurations to the UE 110. Each set of measurement configurations may be associated with an index. The gNB-CU 120 may transmit a RRC message comprising the plurality set of measurement configurations to the UE 110. The gNB-CU 120 may use the first gNB-DU 130 to relay the RRC message to the UE 110. The first gNB-DU 130 may transmit, to the UE 110, an index of the set of measurement configurations among the plurality sets of measurement configurations. The UE 110 may receive the index of the set of measurement configurations among the plurality sets of measurement configurations. In this way, the measurement configurations may be provided in a secure way.

In some example embodiments, the first gNB-DU 130 may transmit a first L1 signaling or a first L2 message comprising the index of the set of measurement configurations to the UE 110. The UE 110 may receive the index of the set of measurement configurations through a first L1 signaling or a first L2 message. In this way, the measurement configurations may be provided with reduced latency.

In some example embodiments, the UE 110 may transmit a second L1 signaling or a second L2 message comprising the measurement report to the first gNB-DU 130. The measurement report 216 may comprise at least indexes of configurations of reference signals in the set of measurement configurations, indexes of configurations of measurements performed by the UE using the reference signals, and measurement results associated with the reference signals or indexes of the measurement results. In this way, the measurement report may be provided to the gNB with reduced latency.

In some example embodiments, the first gNB-DU 130 may receive an indication of completion of the L1/L2-based handover from the target DU through an interface between the first gNB-DU 130 and the target gNB-DU different from the first gNB-DU 130. In this way, resource overhead may be reduced.

In some example embodiments, the gNB-CU 120 may transmit, to the first gNB-DU 130 and the UE 110, a unique identity specific to the UE 110. In some embodiments, transmissions of at least one of L1 signaling or L2 messages between the gNB-DU and the UE may comprise the unique identity specific to the UE. Alternatively, transmissions of at least one of L1 signaling or L2 messages between the gNB-DU and the UE are based on secure operations associated with a value of the unique identity or associated with a parameter of the unique identity incremented in a predefined sequential manner. As such, information in L1 signaling or L2 messages may be provided in a secure way.

In some example embodiments, the gNB-CU 120 may transmit, to a candidate gNB-DU to which a candidate cell of the set of candidate cells belongs, the unique identity specific to the UE 110. In this manner, transmissions between the candidate gNB-DU and the UE may be enabled in a secure way.

In some example embodiments, the UE 110 may transmit, to a target gNB-DU, of the base station, to which the target cell belongs, a message 3 (Msg3) comprising the unique identity specific to the UE 110. For example, in some embodiments where the target cell is cell 141, the UE 110 may transmit, to the second gNB-DU 140, a Msg3 comprising the unique identity specific to the UE 110 when performing the L1/L2-based handover to the cell 141, if RACH is needed. In this way, the L1/L2-based handover may be performed in a secure way.

In some example embodiments, the UE 110 may evaluate the set of L1/L2-based conditional trigger configurations based on evaluating L1/L2-based conditional trigger configurations related to L3-based conditional mobility. In this manner, the handover procedure may be more energy-efficient. In some example embodiments, the UE 110 may evaluate the set of L1/L2-based conditional trigger configurations and L1/L2-based conditional trigger configurations related to L3-based conditional mobility, the total number of evaluations for the set of L1/L2-based conditional trigger configurations and evaluations for the L1/L2-based conditional trigger configurations related to L3-based conditional mobility having a predefined maximum value. In this manner, the handover procedure may be more energy-efficient. In some example embodiments, the UE 110 may maintain the L1/L2-based conditional trigger configuration while performing the L1/L2-based handover to the target cell. In this manner, resource overhead may be reduced.

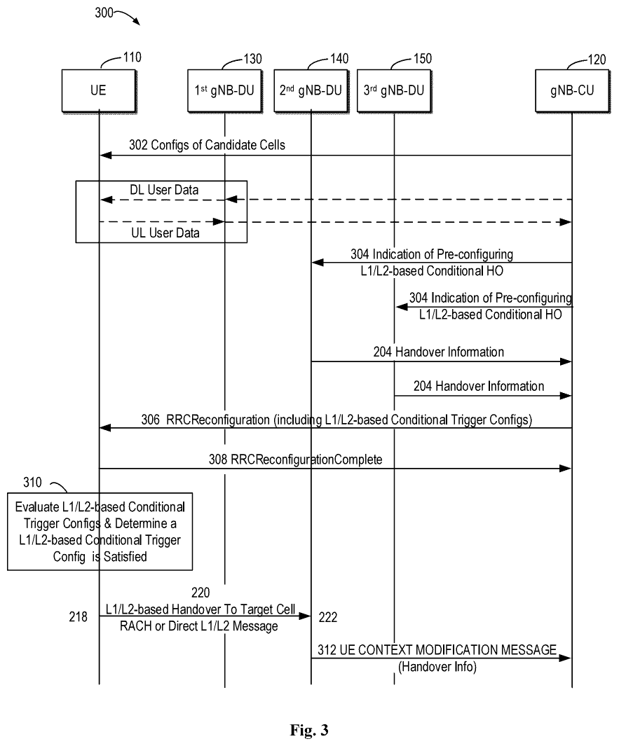

Hereinafter, some embodiments of the L1/L2-based mobility procedure will be described below with reference to FIGS. 3-7. It is noted that the processes 300, 400, 600 and 700 can be considered as more specific examples of the process 200 of FIG. 2.

FIG. 3 illustrates a signaling chart illustrating a process 300 for UE-triggered conditional mobility in accordance with some example embodiments of the present disclosure. For the purpose of discussion, the process 300 will be described with reference to FIG. 1. The process 300 may involve the UE 110, the gNB-CU 120, the first gNB-DU 130, the second gNB-DU 140 and the third gNB-DU 150 in FIG. 1. The same reference numerals are used to denote the steps or components described in FIG. 3 having the same operations as the steps or components described in FIG. 2, and detailed description thereof will be omitted. It is to be understood that the steps and the order of the steps in FIG. 3 are merely for illustration, and not for limitation. For example, the order of the steps may be changed. Some of the steps may be omitted or any other suitable additional steps may be added.

In the process 300, the UE 100 may be provided with configurations 302 of a set of candidate cells for intra-DU and/or inter-DU L1/L2-based mobility. Each candidate gNB-DU to which the candidate cells belong is given a unique identity/signature. The UE 110 may be initially connected to the cell 133 provided by the first gNB-DU 130. Thus, downlink user data to the UE 110 is forwarded from the gNB-CU 120 through the first gNB-DU 130. Also, uplink user data sent from the UE 110 is forwarded to the gNB-CU 120 through the first gNB-DU 130. Based on the configurations 302 of a set of candidate cells, the UE 110 may directly perform a L1/L2-based handover to a target cell selected from the multiple candidate cells based on the pre-configured configuration of the target cell when a L1/L2-based handover is triggered.

The gNB-CU 120 may transmit, to at least one candidate gNB-DU (e.g., the second gNB-DU 140 and the third gNB-DU 150), an indication 304 of pre-configuring a L1/L2-based conditional handover of the UE 110. In turn, the at least one candidate gNB-DU may transmit handover information 204 associated with candidate cell(s) of the candidate gNB-DU. In this manner, the gNB-CU 120 may get relevant information from candidate gNB-DUs using F1 interface and also preconfigure candidate gNB-DUs for L1/L2-based conditional handover of the UE 110. The handover information 204 may comprise, but not limited to, measurement configurations corresponding candidate cells, such as, the configuration of reference signals, the configuration of what needs to be measured by the UE using these reference signals, the configuration of what type of reporting the UE needs to do, and the associated QCL information.

Based on the handover information 204 received from the candidate gNB-DUs, the gNB-CU 120 may determine corresponding L1/L2-based conditional trigger configurations of the candidate cells. In some embodiments, the gNB-CU 120 may form a security protected RRC message (RRCReconfiguration) 306 to be provided to the UE 110. The gNB-CU 120 may use the first gNB-DU 130 to relay this RRC message comprising measurement configurations and the L1/L2-based conditional trigger configurations. The measurement configuration can be provided per candidate serving cell or provided as a separate configuration independent of serving cell configuration. The UE 110 may transmit an RRCReconfigurationComplete message 308 to the gNB-CU 120 indication the completion of the RRC message 304.

The UE 110 may evaluate the L1/L2-based conditional trigger configurations for the candidate cells. If one L1/L2-based conditional trigger configuration is satisfied, the UE 110 may perform a L1/L2-based handover 228 from a source cell of the first gNB-DU 130 to the target cell associated with the conditional trigger configuration. In embodiments where the target cell is selected from a subset of candidate cells for inter-DU mobility among the set of candidate cells, e.g., if the target cell is cell 141, the UE 110 may perform a L1/L2-based handover to the target cell 141 by performing an inter-DU mobility procedure. The second gNB-DU 140 may transmit an indication of confirmation of successful handover to the first gNB-DU 130 through an interface between the first gNB-DU 130 and the second gNB-DU 140. The second gNB-DU 140 may also transmit a UE CONTEXT MODIFICATION MESSAGE 312 comprising handover information to the gNB-CU 120.

In embodiments where the target cell is selected from a subset of candidate cells for intra-DU mobility among the set of candidate cells, e.g., if the target cell is cell 132, the UE 110 may perform a L1/L2-based handover to the target cell 132 by performing an intra-DU mobility procedure. The first gNB-DU 130 may transmit a UE CONTEXT MODIFICATION MESSAGE comprising handover information to the gNB-CU 120.

In some embodiments, the UE 110 may also be provided with a unique identity given previously in the RRC message as confirmation. The unique identity may be a result of a secure action on the previous RRC given identity (e.g., a hashed version, or a ciphered and/or integrity protection added version). The gNB-CU may also provide the candidate gNB-DUs about the needed keys to verify the UE. The needed keys are provided as part of the candidate DU configuration, previously before the handover initiation. For example, if RACH is needed for the handover, the UE 110 may transmit MSG3 including the RRC provided signature/unique identity of the target cell. In some embodiments, the UE may also include the C-RNTI MAC CE using the C-RNTI provided in previous process. Alternatively, in the case of L1 handover, the PUCCH on the target gNB-DU may include the signature. If the handover 220 is based on L1, the UE 110 may continue with PDCCH monitoring on the target cell.

In some embodiments, the L1/L2-based conditional trigger configurations may be provided in various manners. For example, the L1/L2-based conditional trigger configurations may be contained with pre-configuration of the L1/L2 candidate cells. The L1/L2-based conditional trigger configurations may be provided per each candidate cell. Alternatively or additionally, the L1/L2-based conditional trigger configurations may be part of the RRC message that carries the configurations 302 of the set of candidate cells for intra-DU and/or inter-DU L1/L2-based mobility.

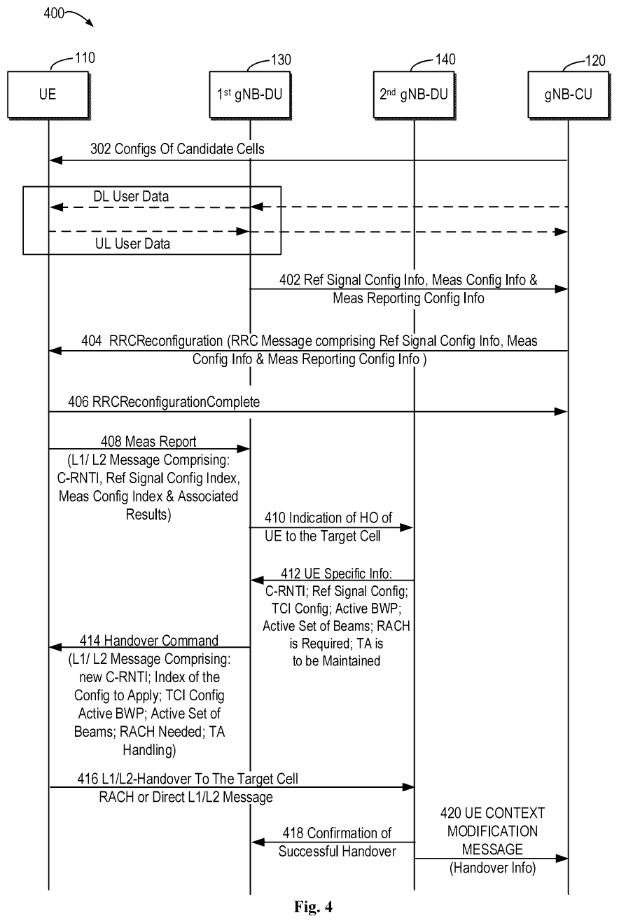

Alternatively, the configurations 302 of the set of candidate cells may be firstly provided to the UE 110 and the L1/L2-based conditional trigger configurations may be provided as a separate RRC message. The configurations 302 of the set of candidate cells and the L1/L2-based conditional trigger configurations may be linked with a reference ID. The UE 110 may apply the conditional aspects when this RRC message containing the L1/L2-based conditional trigger configurations is received. Until the L1/L2-based conditional trigger configurations are provided, the UE considers the L1/L2-based mobility as triggered by the network. With L1/L2-based mobility, the network may change the pre-configuration of the candidate cells. In this way, L1/L2-based mobility may be network triggered or conditional UE-triggered. Details of network triggered L1/L2-based handover procedure when the UE receives the configurations 302 of the set of candidate cells without receiving the L1/L2-based conditional trigger configurations will be described with reference to FIG. 4.

In some embodiments, the network may provide the L1/L2-based conditional trigger configurations in a separate container that also contains the pre-configuration of the L1/L2 candidate cells. Both the L1/L2-based conditional trigger configuration and the associated pre-configuration are part of the same configuration.

In some embodiments, the UE 110 may evaluate the L1/L2-based conditional triggers separately from the L3-based conditional triggers. The total number of evaluations can be capped such that they are shared between the L1/L2-based conditional triggers and the L3-based conditional triggers. Alternatively, evaluations associated with L1/L2-based conditional triggers are on top of UEs capability for evaluations associated with L3-based conditional triggers. Once a trigger is satisfied, the UE 100 would not release the L1/L2-based conditional trigger configuration. The UE 110 may then continue the L1/L2 handover with the information from the L1/L2-based conditional trigger configuration as if the NW has provided a NW-triggered L1/L2 handover command.

FIG. 4 illustrates a signaling chart illustrating a process for L1/L2-based mobility triggered by NW in accordance with some example embodiments of the present disclosure. For the purpose of discussion, the process 400 will be described with reference to FIG. 1. The process 400 may involve the UE 110, the gNB-CU 120, the first gNB-DU 130 and the second gNB-DU 140 in FIG. 1. The same reference numerals are used to denote the steps or components described in FIG. 4 having the same operations as the steps or components described in FIGS. 2 and 3, and detailed description thereof will be omitted. It is to be understood that the steps and the order of the steps in FIG. 4 are merely for illustration, and not for limitation. For example, the order of the steps may be changed. Some of the steps may be omitted or any other suitable additional steps may be added.

In the process 400, the UE 100 may be provided with configurations 302 of a set of candidate cells for intra-DU and/or inter-DU L1/L2-based mobility. The first gNB-DU 130 may provide the gNB-CU 120 with necessary reference signal configuration information, measurement configuration information and measurement reporting configuration information using the F1 interface. For example, the information 402 provided by the first gNB-DU 130 to the gNB-CU 120 may include, but not limited to, the configuration of reference signals, the configuration of what needs to be measured by the UE using these reference signals, the configuration of what type of reporting the UE needs to do, and the associated QCL information. The gNB-CU 120 may form a security protected RRC message (RRCReconfiguration) 404 to be provided to the UE 110. The measurement configuration can be provided per candidate serving cell or provided as a separate configuration independent of serving cell configuration. The UE 110 may transmit an RRCReconfigurationComplete message 406 to the gNB-CU 120 indicating the completion of the RRC message 404.

In some embodiments, the UE 110 may use L1 signaling or L2 message (e.g., MEAC CE) to provide the measurement report 408. For example, the L1 signaling or L2 message may comprise C-RNTI, indexes of configurations of reference signals, indexes of configurations of what need to be measured by the UE using the reference signals, and associated measurement results. For example, for each measurement configuration, an index to the measurement configuration and the associated results may be included in the measurement report. The associated measurement results may comprise either absolute values for the results or a look-up-table indexed form where only the index is reported. If the UE is not provided with the L1/L2-based conditional trigger configurations, the first gNB-DU 130 may decide whether a L1/L2-based handover needs to be triggered and the target cell of the UE based on the measurement report 216.

For example, if the target cell is cell 141, the UE 110 may perform a handover to the target cell 141 by performing an inter-DU mobility procedure. In some examples, the first gNB-DU 130 may use an interface between the first gNB-DU 130 and the second gNB-DU 140 to inform the second gNB-DU 140 and to get the latest configuration of the target cell 141. For example, the first gNB-DU 130 may transmit, to the second gNB-DU 140, an indication 410 of handover of the UE 110 to the target cell 141. The first gNB-DU 130 may receive UE specific information 412 from the second gNB-DU 140. The UE specific information 412 may include, but not limited to, C-RNTI, reference signal configuration, TCI configuration, active BWP, an active set of beams, an indication of if RACH is needed, and an indication of if TA needs to be maintained. Alternatively, the first gNB-DU 130 may use the F1 interface to indicate the gNB-CU 120 about a handover of the UE 110 to the target cell 141. The gNB-CU 120 may forward the indication to second gNB-DU 140 and forward the UE specific information from the second gNB-DU 140 to the first gNB-DU 130.

In case the target cell is cell 132, the UE 110 may perform a handover to the target cell 132 by performing an intra-DU mobility procedure. The first gNB-DU 130 may directly obtain the UE specific information for the cell 132.

In some embodiments, the first gNB-DU 130 may transmit the handover command 414, including the UE specific information for the target cell, to the UE 110. For example, the first gNB-DU 130 may form a MAC CE (in case of L2-based handover) or L1 DCI (in case of L1-based handover). The handover command 414 may include, but not limited to, new C-RNTI (if not provided already), TCI configuration, index of the configuration to be applied (if multiple configurations are provided), active BWP, an active set of beams, an indication of if RACH is needed, and an indication of if TA needs to be maintained.

In some embodiments, the UE 110 may perform a handover 416 from a source cell of the first gNB-DU 130 to the target cell based on the handover command 414. In case of inter-DU mobility, e.g., if the target cell is cell 141, the second gNB-DU 140 may transmit an indication 418 of confirmation of successful handover to the first gNB-DU 130 through an interface between the first gNB-DU 130 and the second gNB-DU 140. The second gNB-DU 140 may also transmit a UE CONTEXT MODIFICATION MESSAGE 420 comprising handover information to the gNB-CU 120.

As mentioned above, in some embodiments, before the L1/L2-based conditional trigger configurations are provided, configurations 302 of candidate cells provided to UE may be used for NW-triggered L1/L2-based mobility; while once the L1/L2-based conditional trigger configurations are provided, configurations 302 of candidate cells provided to UE may be used for conditional UE-triggered L1/L2-based mobility.

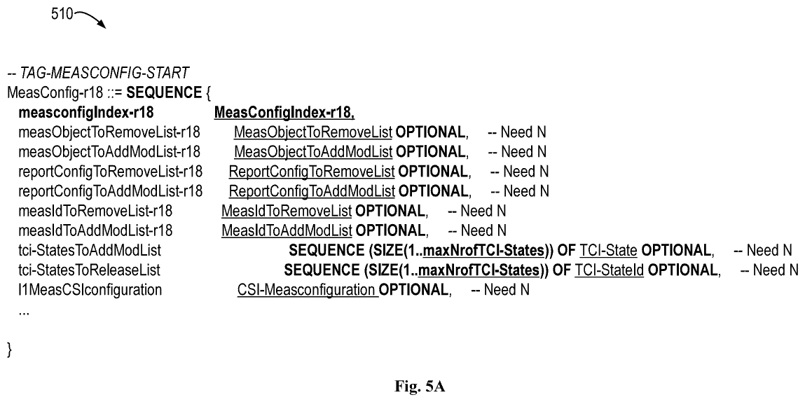

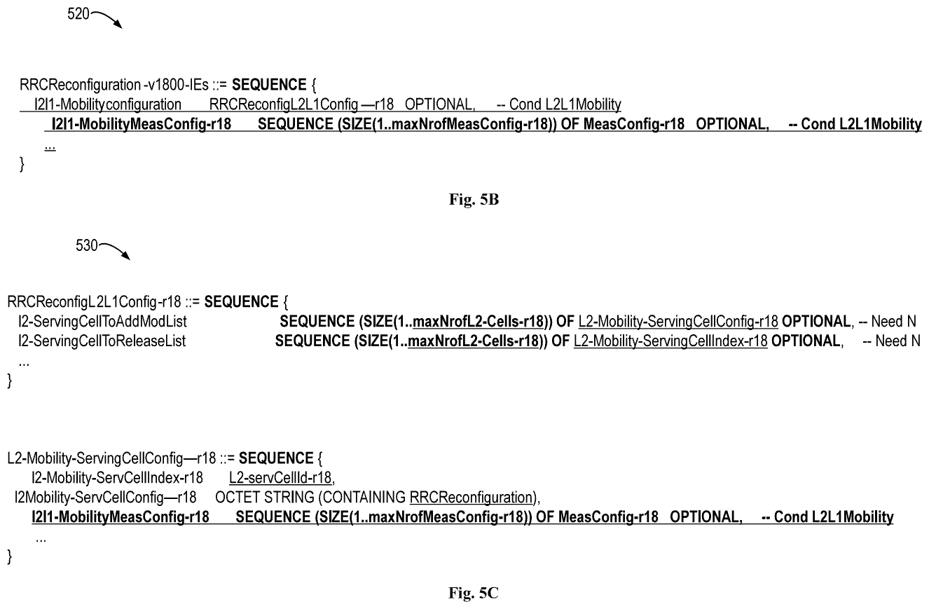

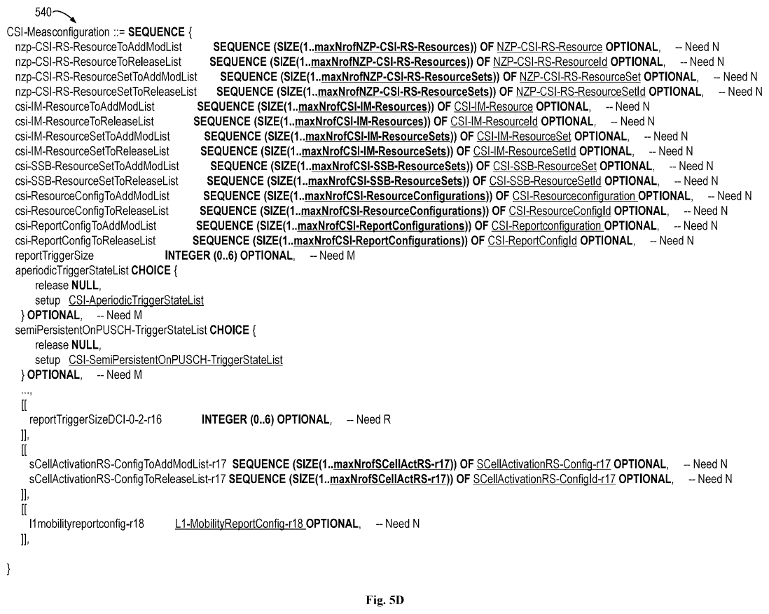

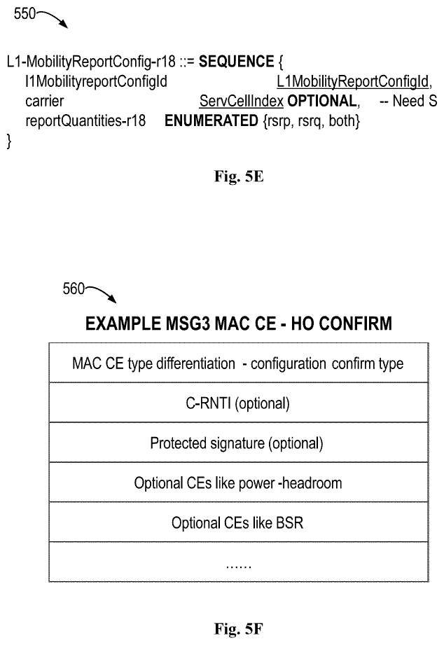

FIG. 5A illustrates an exemplary IE 510 reusing the existing measurement configuration in accordance with some example embodiments of the present disclosure. The information element (IE) 310 may comprise measurement configurations of candidate cells and corresponding indexes and may be used as the RRC message 306 in the process 300 or the RRC message 404 in the process 400. In the example of FIG. 5A, the gNB-CU 120 may reuse the existing measurement configuration including using the measurement objects and ID configuration.

FIG. 5B illustrates an exemplary IE 520 for measurement configuration for L1/L2-based mobility in accordance with some example embodiments of the present disclosure. The IE 320 may be used as the RRC message 306 in the process 300 or the RRC message 404 in the process 400. In the example of FIG. 5B, a separate set of measurement configuration may be included for L1/L2-based mobility, but this configuration is not specific to any L1/L2 candidate cell configuration.

FIG. 5C illustrates an exemplary IE 530 for measurement configuration specific to a L1/L2 candidate cell configuration in accordance with some example embodiments of the present disclosure. The IE 530 may be used as the RRC message 306 in the process 300 or the RRC message 404 in the process 400. In the example of FIG. 5C, a separate set of measurement configuration may be included for L1/L2-based mobility, where each set of measurement configuration is part of the L1/L2 candidate cell configuration.

FIG. 5D illustrates an exemplary IE 540 for CSI measurement configuration in accordance with some example embodiments of the present disclosure. In the example of FIG. 5D, multiple sets of measurement configurations, including configurations of the CSI-RS signals and the reporting configurations, etc., may be provided. Each set is qualified by an index. The UE 110 may thus be switched to change the measurement configuration using L1 signaling or L2 message comprising the index of the measurement configuration.

FIG. 5E illustrates an exemplary IE 550 for report configuration in accordance with some example embodiments of the present disclosure. In the example of FIG. 5E, an index of reporting configurations and the index of corresponding candidate cell may be provided.

FIG. 5F illustrates an exemplary MSG3 MAC CE 560 for handover confirmation in accordance with some example embodiments of the present disclosure. The MSG3 MAC CE 560 may be used in the handover 220 in the process 300 or the handover 416 in the process 400. As shown in FIG. 5F, a protected signature may be provided in the MSG3 MAC CE 530.

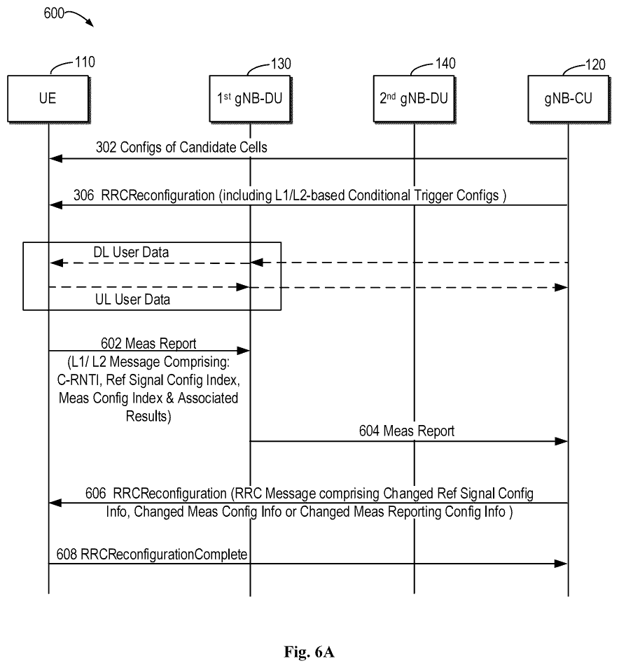

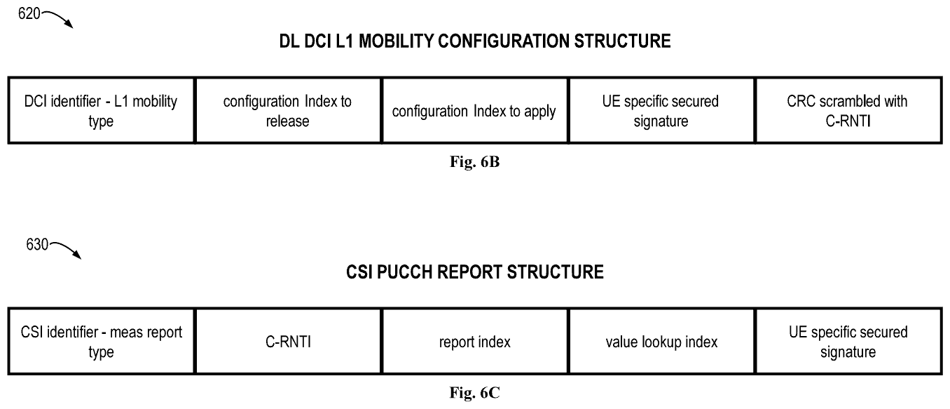

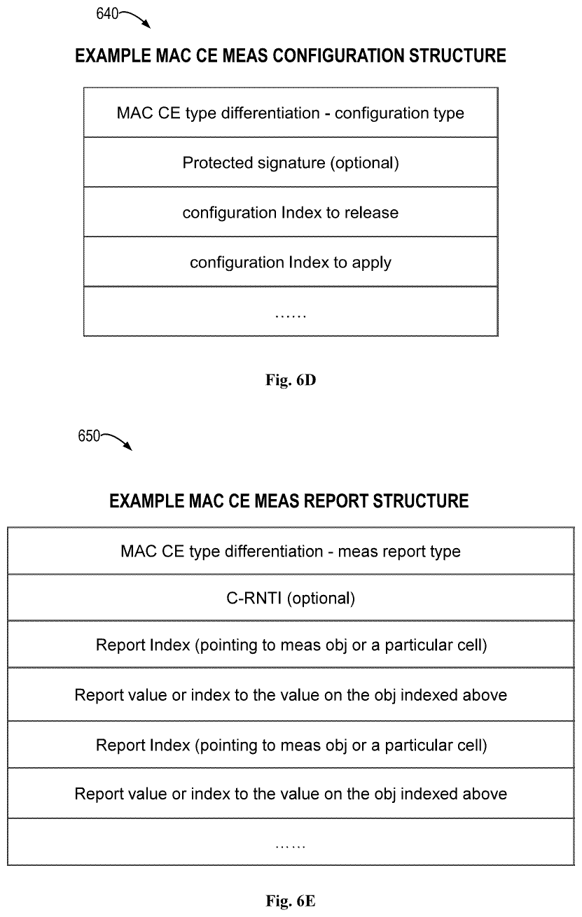

FIG. 6A illustrates a signaling chart illustrating a process 600 for measurement reporting and re-configuration of UE in accordance with some example embodiments of the present disclosure. For the purpose of discussion, the process 600 will be described with reference to FIG. 1. The process 400 may involve the UE 110, the gNB-CU 120, the first gNB-DU 130 and the second gNB-DU 140 in FIG. 1. The same reference numerals are used to denote the steps or components described in FIG. 6A having the same operations as the steps or components described in FIGS. 2 and 3, and detailed description thereof will be omitted. It is to be understood that the steps and the order of the steps in FIG. 6A are merely for illustration, and not for limitation. For example, the order of the steps may be changed. Some of the steps may be omitted or any other suitable additional steps may be added.

In the process 600, the UE 110 may use L1 signaling or L2 message (e.g., MEAC CE) to provide the measurement report 602. For example, the L1 signaling or L2 message may comprise C-RNTI, indexes of configurations of reference signals, indexes of configurations of what need to be measured by the UE using the reference signals, and associated measurement results. For example, for each measurement configuration, an index to the measurement configuration and the associated results may be included in the measurement report. The associated measurement results may comprise either absolute values for the results or a look-up-table indexed form where only the index is reported.

In some embodiment, the first gNB-DU 130 may transmit 604 the measurement report to the gNB-CU 120 using the F1 interface. The gNB-CU 120 may provide the associated RRC message (RRCReconfiguration) 606 to the UE 110. The RRC message 606 may comprise changed reference signal configuration, changed measurement configuration or changed measurement reporting configuration. Alternatively, the first gNB-DU 130 may transmit changed reference signal configuration information, changed measurement configuration information or changed measurement reporting configuration information to the gNB-CU 120 using the F1 interface. The gNB-CU 120 may provide the associated RRC message (RRCReconfiguration) to the UE 110. Alternatively, the first gNB-DU 130 may provide a MAC CE-based switch of measurement configuration, in which the index of measurement configuration which the UE 110 should apply is provided. The association of the index to the necessary measurement configuration is provided previously using RRC message 306 in FIG. 3. The UE 110 may transmit a RRCReconfigurationComplete message 608 to the gNB-CU 120 indicating the completion of the RRC message 606.

FIG. 6B illustrates an exemplary DL DCI L1 mobility configuration message 620 for measurement reconfiguration in accordance with some example embodiments of the present disclosure. The DL DCI L1 mobility configuration message 620 may be used in the process 600. As shown in FIG. 6B, the UE 110 is informed to change from the measurement configuration corresponding to the IE “Config Index to release” to the measurement configuration corresponding to “Config Index to apply”.

FIG. 6C illustrates an exemplary CSI PUCCH report message 630 in accordance with some example embodiments of the present disclosure. The CSI PUCCH report message 630 may be used for the measurement report 408 in the process 400 and the measurement report 602 in the process 600. As shown in FIG. 6C, the CSI PUCCH report message 630 may comprise an index of the report indicating the measurement object or particular cell and the value of an look-up-table index.

FIG. 6D illustrates an exemplary MAC CE measurement configuration message 640 for measurement reconfiguration in accordance with some example embodiments of the present disclosure. The MAC CE measurement configuration message 640 may be used in the process 600. As shown in FIG. 6D, the UE 110 is informed to change from the measurement configuration corresponding to the IE “Config Index to release” to the measurement configuration corresponding to “Config Index to apply”.

FIG. 6E illustrates an exemplary MAC CE measurement report message 650 in accordance with some example embodiments of the present disclosure. The MAC CE measurement report message 650 may be used for the measurement report 408 in the process 400 and the measurement report 602 in the process 600. As shown in FIG. 6C, the MAC CE measurement report message 650 may comprise an index of the report indicating the measurement object or particular cell and the value of an look-up-table index.

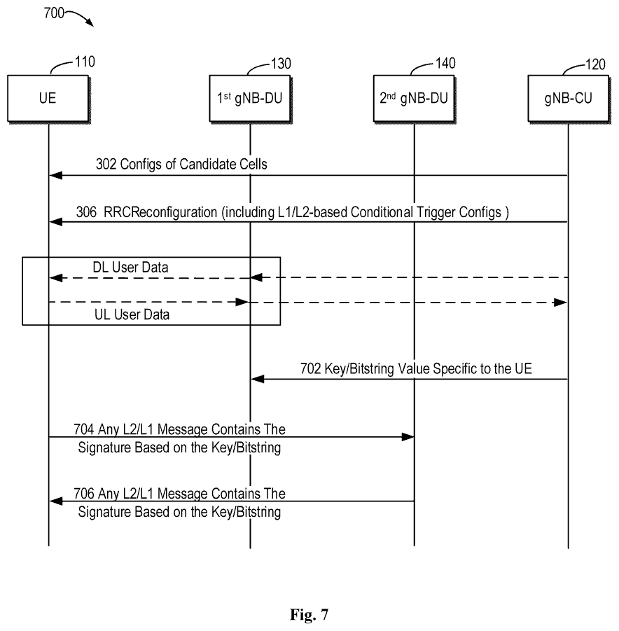

FIG. 7 illustrates a signaling chart illustrating a process 700 for protective L1 signaling and L2 messages in accordance with some example embodiments of the present disclosure. For the purpose of discussion, the process 700 will be described with reference to FIG. 1. The process 700 may involve the UE 110, the gNB-CU 120, the first gNB-DU 130 and the second gNB-DU 140 in FIG. 1. The same reference numerals are used to denote the steps or components described in FIG. 7 having the same operations as the steps or components described in FIGS. 2 and 3, and detailed description thereof will be omitted. It is to be understood that the steps and the order of the steps in FIG. 7 are merely for illustration, and not for limitation. For example, the order of the steps may be changed. Some of the steps may be omitted or any other suitable additional steps may be added.

In some embodiments, in order to transmit the L1 signaling and the L2 message between the gNB-DU and the UE in a secure way, the UE 110 may be provided with a key/bitstring value specific to the UE 110. The gNB-CU 120 may provide the same key/bitstring value to all gNB-DUs. Any L1/L2 message 704 from the gNB-DU contain the signature which is based from the key/bitstring given to gNB-DUs by gNB-CU 120. The UE may discard the message 704, if the check is not matched. Similarly, any L1/L2 message 706 to the gNB-DUs from UE 110 may contain the signature which is based from the key/bitstring given to UE by gNB-CU 120. The gNB-DU may discard the message 704, if the check is not matched.

In some embodiments, the UE 110 may be provided with a value of fixed bitstring size. In some embodiments, the UE may be configured with a value. The value may be a random value of fixed bitsize. Alternatively, the value may be based on temporary UE identity or an identity the UE is aware. Alternatively, the value may be based on existing security parameters.

For every MAC CE in the UL related to L2 mobility (for example, in the measurement report or handover message to the target gNB-DU with a MSG3 MAC CE), the UE may send this value back. Alternatively, the UE may perform a secure operation on this value and reports the outcome. For example, the secure operation may be a hashing function or a stream ciphering. The secure operation may also use a parameter that is incremented in a sequential manner that both the UE and the gNB knows. In this way, upon receiving a L2 message, the gNB is able to verify that the UE transmitting the L2 message is indeed the UE that was previously sent the RRC protection message.

Every MAC CE in the DL related to L2 mobility (for example, change of measurement configuration in L2 message), the gNB may send, in L2 message, similar value with the variations as stated in the UL. In this way, upon receiving a L2 message, the UE is able to know that the gNB transmitting the L2 message is indeed the same gNB that has previously sent the RRC message to the UE.

The receiver of the L2 message may calculate the expected value/key/bitstring based on the received value/key/bitstring in the message. If they do not match, the message may be discarded.

The L1 signaling may be transmitted and verified by the receiver in a similar manner as the L2 message. For example, the DCI for DL may carry the signature/key/bitstring specific to the UE. The PUCCH or PUSCH for UL may carry the signature/key/bitstring specific to the UE.

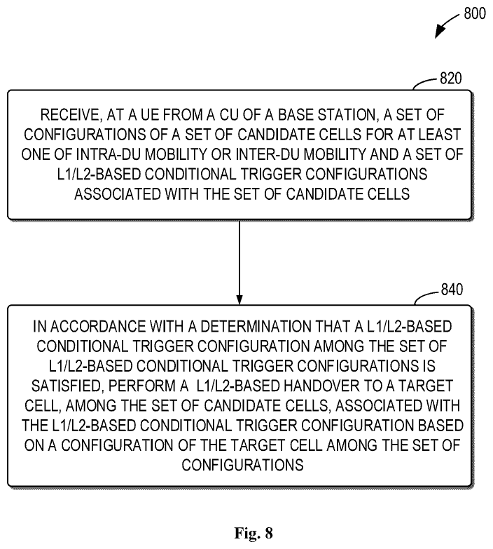

FIG. 8 illustrates a flowchart illustrating an example method 800 for L1/L2-based conditional mobility implemented at a UE according to some embodiments of the present disclosure. For the purpose of discussion, the method 800 will be described from the perspective of the UE 110 with reference to FIG. 1. With the method 800 of FIG. 8, the latency for handover procedure may be reduced based on the pre-configured configuration of the candidate cells at the UE.

At block 820, the UE 110 receives, from the CU 120 of a base station, a set of configurations of a set of candidate cells for at least one of intra-DU mobility or inter-DU mobility and a set of L1/L2-based conditional trigger configurations associated with the set of candidate cells. At block 840, if a L1/L2-based conditional trigger configuration among the set of L1/L2-based conditional trigger configurations is satisfied, the UE 110 performs a L1/L2-based handover to a target cell, among the set of candidate cells, associated with the L1/L2-based conditional trigger configuration based on a configuration of the target cell among the set of configurations.

In some embodiments, in order to receive the set of configurations and the set of L1/L2-based conditional trigger configurations, the UE 110 may receive from the CU 120, a first RRC message comprising the set of configurations and a second RRC message different from the first RRC message. The second RRC message may comprise the set of L1/L2-based conditional trigger configurations, and an indicator associating one of the set of L1/L2-based conditional trigger configurations with one of the set of candidate cells.

In some embodiments, in order to receive the set of configurations and the set of L1/L2-based conditional trigger configurations, the UE 110 may receive, from the CU 120, a RRC message comprising the set of configurations and the set of L1/L2-based conditional trigger configurations. In some embodiments, the UE 110 may obtain a set of measurement configurations for the set of candidate cells and transmit, to a DU 130 of the base station serving the UE, a measurement report associated with the set of measurement configurations.

In some embodiments, the set of measurement configurations may comprise at least one of: configurations of reference signals to be received from the set of candidate cells, configurations of measurements to be performed by the UE 110 using the reference signals, a reporting type associated with the measurements, or QCL information associated with the reference signals.

In some embodiments, in order to obtain the set of measurement configurations, the UE 110 may receive, from the CU 120, a RRC message comprising the set of measurement configurations. In some embodiments, in order to obtain the set of measurement configurations, the UE 110 may receive, from the CU 120, a RRC message comprising a plurality sets of measurement configurations and receive, from the DU 130, an index of the set of measurement configurations among the plurality sets of measurement configurations. In some embodiments, in order to receive the index of the set of measurement configurations, the UE 110 may receive a first L1 signaling or a first L2 message from the DU 130, the first L1 signaling or the first L2 message comprising the index of the set of measurement configurations.

In some embodiments, in order to transmit the measurement report, the UE 110 may transmit, to the DU 130, a second L1 signaling or a second L2 message comprising the measurement report. The measurement report may comprise at least: indexes of configurations of reference signals in the set of measurement configurations, indexes of configurations of measurements performed by the UE 110 using the reference signals, and measurement results associated with the reference signals or indexes of the measurement results.

In some embodiments, the UE 110 may further receive, from the CU 120, a unique identity specific to the UE 110. In some embodiments, transmissions of at least one of L1 signaling or L2 messages between the DU 130 and the UE 110 may comprise the unique identity specific to the UE 110. In some embodiments, transmissions of at least one of L1 signaling or L2 messages between the DU 130 and the UE 110 may be based on secure operations associated with a value of the unique identity or associated with a parameter of the unique identity incremented in a predefined sequential manner. In some embodiments, in order to perform the L1/L2-based handover, the UE 110 may transmit, to a target DU 140, of the base station, to which the target cell belongs, a message 3 (Msg3) comprising the unique identity specific to the UE.

In some embodiments, the UE 110 may further evaluate the set of L1/L2-based conditional trigger configurations based on evaluating L1/L2-based conditional trigger configurations related to L3-based conditional mobility. In some embodiments, the UE 110 may further evaluate the set of L1/L2-based conditional trigger configurations and L1/L2-based conditional trigger configurations related to L3-based conditional mobility. The total number of evaluations for the set of L1/L2-based conditional trigger configurations and evaluations for the L1/L2-based conditional trigger configurations related to L3-based conditional mobility may have a predefined maximum value. In some embodiments, in order to perform the L1/L2-based handover, the UE 110 may maintain the L1/L2-based conditional trigger configuration while performing the L1/L2-based handover to the target cell.

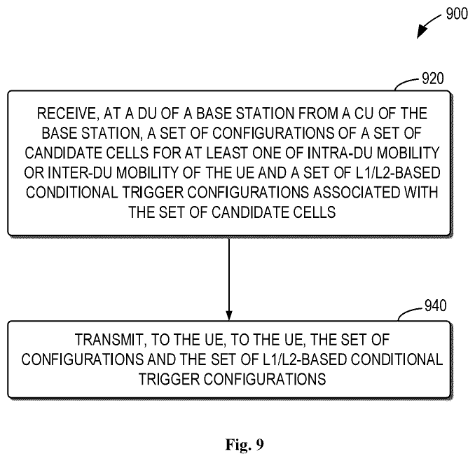

FIG. 9 illustrates a flowchart illustrating an example method 900 for L1/L2-based conditional mobility implemented at a source DU of a BS according to some embodiments of the present disclosure. For the purpose of discussion, the method 900 will be described from the perspective of the DU 130 with reference to FIG. 1. With the method 900 of FIG. 9, the latency for handover procedure may be reduced.

At block 920, the DU 130 receives from a CU 120 of the base station, a set of configurations of a set of candidate cells for at least one of intra-DU mobility or inter-DU mobility of the UE 110 and a set of L1/L2-based conditional trigger configurations associated with the set of candidate cells. At block 940, the DU 130 transmits, to the UE 110, the set of configurations and the set of L1/L2-based conditional trigger configurations.

In some embodiments, the DU 130 may further transmit, to the CU 120 through a F1 interface, a set of measurement configurations of the set of candidate cells; receive a RRC message comprising the set of measurement configurations from the CU 120; and transmit the RRC message to the UE 110.

In some embodiments, the DU 130 may further receive a RRC message from the CU, the RRC message comprising a plurality sets of measurement configurations of the set of candidate cells; transmit the RRC message to the UE 110; and transmit, to the UE 110, an index of the set of measurement configurations among the plurality sets of measurement configurations.

In some embodiments, when transmitting the index of the set of measurement configurations, the DU 130 may transmit a first L1 signaling or a first L2 message to the UE 110, the first L1 signaling or the first L2 message comprising the index of the set of measurement configurations.

In some embodiments, the set of measurement configurations may comprise at least one of: configurations of reference signals to be received by the UE 110 from the set of candidate cells, configurations of measurements to be performed by the UE 110 using the reference signals, a reporting type associated with the measurements, or QCL information associated with the reference signals.

In some embodiments, the DU 130 may receive, from the UE 110, a measurement report associated with the set of measurement configurations for the set of candidate cells; and determine a second set of measurement configurations based on the measurement report.

In some embodiments, when receiving the measurement report, the DU 130 may receive a second L1 signaling or a second L2 message comprising the measurement report from the UE 110. The measurement report may comprise at least: indexes of configurations of reference signals in the set of measurement configurations, indexes of configurations of measurements performed by the UE 110 using the reference signals, and measurement results associated with the reference signals or indexes of the measurement results.

In some embodiments, the DU 130 may further receive, from a target DU 140 of the base station through an interface between the DU and the target DU, an indication of completion of a L1/L2-based handover of the UE to a target cell, among the set of candidate cells, the target cell belonging to the target DU different from the DU.

In some embodiments, the DU 130 may further receive, from the CU 120, a unique identity specific to the UE 110. In some embodiments, transmissions of at least one of L1 signaling or L2 messages between the DU 130 and the UE 110 may comprise the unique identity specific to the UE 110. In some embodiments, transmissions of at least one of L1 signaling or L2 messages between the DU 130 and the UE 110 may be based on secure operations associated with a value of the unique identity or associated with a parameter of the unique identity incremented in a predefined sequential manner.

In some embodiments, in order to receive the set of configurations and the set of L1/L2-based conditional trigger configurations, the DU 130 may receive from the CU 120, a first RRC message comprising the set of configurations and a second RRC message different from the first RRC message. The second RRC message may comprise the set of L1/L2-based conditional trigger configurations, and an indicator associating one of the set of L1/L2-based conditional trigger configurations with one of the set of candidate cells. In some embodiments, in order to receive the set of configurations and the set of L1/L2-based conditional trigger configurations, the DU 130 may receive, from the CU 120, a RRC message comprising the set of configurations and the set of L1/L2-based conditional trigger configurations.

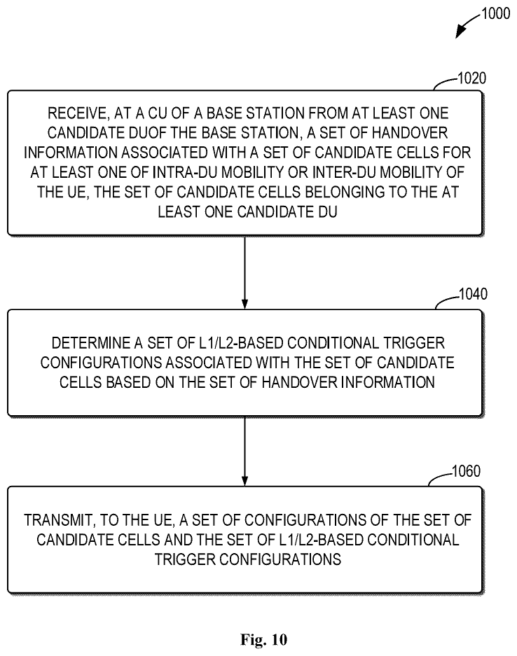

FIG. 10 illustrates a flowchart illustrating an example method 1000 for L1/L2-based conditional mobility implemented at a CU of a BS according to some embodiments of the present disclosure. For the purpose of discussion, the method 1000 will be described from the perspective of the CU 120 with reference to FIG. 1. With the method 1000 of FIG. 10, the latency for handover procedure may be reduced.

At block 1020, the CU 120 receives, from at least one candidate DU 140 of the base station, a set of handover information associated with a set of candidate cells for at least one of intra-DU mobility or inter-DU mobility of the UE, the set of candidate cells belonging to the at least one candidate DU. At block 1040, the CU 120 determines a set of L1/L2-based conditional trigger configurations associated with the set of candidate cells based on the set of handover information. At block 1060, the CU 120 transmits, to the UE 110, a set of configurations of the set of candidate cells and the set of L1/L2-based conditional trigger configurations.

In some embodiments, the CU 120 may further receive, from the DU 130 through a F1 interface, a set of measurement configurations for the set of candidate cells and transmit a RRC message to the UE 110, the RRC message comprising the set of measurement configurations. In some embodiments, the CU 120 may further transmit a RRC message to the DU 130 and the UE 110, the RRC message comprising a plurality sets of measurement configurations, each set being associated with an index. In some embodiments, the CU 120 may further transmit, to a candidate DU 140 to which a candidate cell of the set of candidate cells belongs, an indication of pre-configuring a L1/L2-based conditional handover of the UE 110.

In some embodiments, the CU 120 may further transmit, to the DU 130 and the UE 110, a unique identity specific to the UE 110. In some embodiments, the CU 120 may further transmit, to a candidate DU 140 to which a candidate cell of the set of candidate cells belongs and to the UE 110, a unique identity specific to the UE 110. In some embodiments, the CU 120 may further receive, from a target DU 140 to which a target cell among the set of candidate cells belong, an indication of completion of a L1/L2-based handover of the UE 110 to the target cell.

In some embodiments, when transmitting the set of configurations and the set of L1/L2-based conditional trigger configurations, the CU 120 may transmit to the UE 110, a first RRC message comprising the set of configurations; and transmit to the UE 110, a second RRC message different from the first RRC message. The second RRC message may comprise the set of L1/L2-based conditional trigger configurations, and an indicator associating one of the set of L1/L2-based conditional trigger configurations with one of the set of candidate cells.

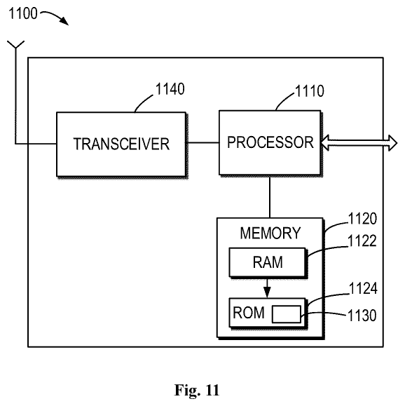

FIG. 11 is a simplified block diagram of a device 1100 that is suitable for implementing embodiments of the present disclosure. For example, the UE 110, the gNB-CU 120, the first gNB-DU 130 or the second gNB-DU 140 can be implemented by the device 1100. As shown, the device 1100 includes a processor 1110, a memory 1120 coupled to the processor 1110, and a transceiver 1140 coupled to the processor 1110.

The transceiver 1140 is for bidirectional communications. The transceiver 1140 is coupled to at least one antenna to facilitate communication. The transceiver 1140 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any method of the disclosure as discussed with reference to FIGS. 8 to 10. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 800 as described above with reference to FIG. 8 and/or the method 900 as described above with reference to FIG. 9 and/or the method 1000 as described above with reference to FIG. 10.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE) comprising:
a transceiver configured to communicate with a network; and
a processor communicatively coupled to the transceiver and configured to perform operations comprising:
receiving, using the transceiver, from a central unit (CU) of a base station, a set of configurations of a set of candidate cells for at least one of intra-distributed-unit (intra-DU) mobility or inter-DU mobility and a set of L1/L2-based conditional trigger configurations associated with the set of candidate cells; and
in accordance with a determination that a L1/L2-based conditional trigger configuration among the set of L1/L2-based conditional trigger configurations is satisfied, performing a L1/L2-based handover to a target cell, among the set of candidate cells, associated with the L1/L2-based conditional trigger configuration based on a configuration of the target cell among the set of configurations.

2. The UE of claim 1, wherein receiving the set of configurations and the set of L1/L2-based conditional trigger configurations comprises:
receiving from the CU, a first Radio Resource Control (RRC) message comprising the set of configurations; and
receiving from the CU, a second RRC message different from the first RRC message, the second RRC message comprising:
the set of L1/L2-based conditional trigger configurations, and
an indicator associating one of the set of L1/L2-based conditional trigger configurations with one of the set of candidate cells.

3. The UE of claim 1, wherein receiving the set of configurations and the set of L1/L2-based conditional trigger configurations comprises:
receiving from the CU, a RRC message comprising the set of configurations and the set of L1/L2-based conditional trigger configurations.

4. The UE of claim 1, wherein the operations further comprises:
obtaining a set of measurement configurations for the set of candidate cells;
transmitting, using the transceiver, to a DU of the base station serving the UE, a measurement report associated with the set of measurement configurations.

5. The UE of claim 4, wherein the set of measurement configurations comprises at least one of:
configurations of reference signals to be received from the set of candidate cells,
configurations of measurements to be performed by the UE using the reference signals,
a reporting type associated with the measurements, or
Quasi Co-Located (QCL) information associated with the reference signals.

6-8. (canceled)

9. The UE of claim 4, wherein transmitting the measurement report comprises:
transmitting, to the DU, a second L1 signaling or a second L2 message comprising the measurement report, the measurement report comprising at least:
indexes of configurations of reference signals in the set of measurement configurations,
indexes of configurations of measurements performed by the UE using the reference signals, and
measurement results associated with the reference signals or indexes of the measurement results.

10. The UE of claim 1, wherein the operations further comprises:
receiving, using the transceiver, from the CU, a unique identity specific to the UE.

11-13. (canceled)

14. The UE of claim 1, wherein the operations further comprises:
evaluating the set of L1/L2-based conditional trigger configurations based on evaluating L1/L2-based conditional trigger configurations related to L3-based conditional mobility.

15. The UE of claim 1, wherein the operations further comprises:
evaluating the set of L1/L2-based conditional trigger configurations and L1/L2-based conditional trigger configurations related to L3-based conditional mobility, the total number of evaluations for the set of L1/L2-based conditional trigger configurations and evaluations for the L1/L2-based conditional trigger configurations related to L3-based conditional mobility having a predefined maximum value.

16. The UE of claim 1, wherein performing the L1/L2-based handover comprises:
maintaining the L1/L2-based conditional trigger configuration while performing the L1/L2-based handover to the target cell.

17. A distributed unit (DU) of a base station, comprising:
a transceiver configured to communicate with a user equipment (UE); and
a processor communicatively coupled to the transceiver and configured to perform operations comprising:
receiving, using the transceiver, from a central unit (CU) of the base station, a set of configurations of a set of candidate cells for at least one of intra-DU mobility or inter-DU mobility of the UE and a set of L1/L2-based conditional trigger configurations associated with the set of candidate cells; and
transmitting, using the transceiver, to the UE, the set of configurations and the set of L1/L2-based conditional trigger configurations.

18. The DU of claim 17, wherein the operations further comprises:
transmitting, using the transceiver, to the CU through a F1 interface, a set of measurement configurations of the set of candidate cells;
receiving, using the transceiver, a Radio Resource Control (RRC) message from the CU, the RRC message comprising the set of measurement configurations; and
transmitting, using the transceiver, the RRC message to the UE.

19. The DU of claim 17, wherein the operations further comprises:
receiving, using the transceiver, a RRC message from the CU, the RRC message comprising a plurality sets of measurement configurations of the set of candidate cells;
transmitting, using the transceiver, the RRC message to the UE; and
transmitting, using the transceiver, to the UE, an index of the set of measurement configurations among the plurality sets of measurement configurations.

20. The DU of claim 19, wherein transmitting the index of the set of measurement configurations comprises:
transmitting, using the transceiver, a first L1 signaling or a first L2 message to the UE, the first L1 signaling or the first L2 message comprising the index of the set of measurement configurations.

21-23. (canceled)

24. The DU of claim 17, wherein the operations further comprises:
receiving, using the transceiver, from a target DU of the base station through an interface between the DU and the target DU, an indication of completion of a L1/L2-based handover of the UE to a target cell, among the set of candidate cells, the target cell belonging to the target DU different from the DU.

25-29. (canceled)

30. A central unit (CU) of a base station, comprising:
a transceiver configured to communicate with a user equipment (UE); and
a processor communicatively coupled to the transceiver and configured to perform operations comprising:
receiving, using the transceiver, from at least one candidate distributed-unit (DU) of the base station, a set of handover information associated with a set of candidate cells for at least one of intra-DU mobility or inter-DU mobility of the UE, the set of candidate cells belonging to the at least one candidate DU;
determining a set of L1/L2-based conditional trigger configurations associated with the set of candidate cells based on the set of handover information; and
transmitting, using the transceiver, to the UE, a set of configurations of the set of candidate cells and the set of L1/L2-based conditional trigger configurations.

31. The CU of claim 30, wherein the operations further comprises:
receiving, using the transceiver, from the DU through a F1 interface, a set of measurement configurations for the set of candidate cells; and
transmitting, using the transceiver, a Radio Resource Control (RRC) message to the UE, the RRC message comprising the set of measurement configurations.

32. The CU of claim 30, wherein the operations further comprises:
transmitting, using the transceiver, a RRC message to the DU and the UE, a RRC message comprising a plurality sets of measurement configurations, each set being associated with an index.

33. The CU of claim 30, wherein the operations further comprises:
transmitting, using the transceiver, to a candidate DU to which a candidate cell of the set of candidate cells belongs, an indication of pre-configuring a L1/L2-based conditional handover of the UE.

34. The CU of claim 30, wherein the operations further comprises:
transmitting, using the transceiver, to the DU and the UE, a unique identity specific to the UE.

35-39. (canceled)
